(19) United States
(12) Patent Application Publication
(10) Pub. No.: US 2014/0137778 A1
(43) Pub. Date: May 22, 2014

(54) METHOD AND APPARATUS FOR REDUCING NOx EMMISIONS AND SLAG FORMATION IN SOLID FUEL FURNACES

(71) Applicant: Power & Industrial Services Corporation, Donora, PA (US)

(72) Inventor: Terry Higgins, Lee's Summit, MO (US)

(73) Assignee: Power & Industrial Services Corporation, Donora, PA (US)

(21) Appl. No.: 14/106,940

(22) Filed: Dec. 16, 2013

Related U.S. Application Data
(63) Continuation-in-part of application No. 13/348,181, filed on Jan. 11, 2012.

(51) Int. Cl. F23J 15/00; B01D 53/56

(52) U.S. Cl. CPC F23J 15/003; B01D 53/56
USPC 110/215; 110/344

(57) ABSTRACT

Selective non-catalytic reduction (SNCR) of pollutant emissions is accomplished in a solid fuel combustion furnace by injecting and directing jet streams of liquid NOx reducing agent, with or without dilution water mixing, into combustion zones and radiant section and convective paths of the furnace with water cannons as controlled by intelligent knowledge-based control algorithms. The control algorithms are based upon continuously monitored online-measured flue gas temperature, O₂, CO and NOx mapping data profiles for the furnace.

### CROSS REFERENCE

This patent application is a continuation-in-part of U.S. patent application Ser. No. 13/348,181, filed on Nov. 1, 2012 which claims the benefit of U.S. Provisional Patent Application No. 61/626,311, filed Sep. 23, 2011, the contents of which are incorporated herein by reference.

### BACKGROUND OF THE INVENTION

This invention relates to multi-tasking the reduction of pollutants, such as nitrogen oxide, in combustion effluent of a carbonaceous fuel with reduction of slag formation. More particularly, this invention relates to a process and apparatus to accomplish this.

The traditional method for cleaning a furnace has been the retractable wall blower which is inserted into the furnace wall through an opening, and the blower tube rotates while a jet of steam or air is sprayed on the furnace wall to remove deposits. However, wall blowers have proven to be inadequate to clean boilers that are burning PRB, lignite, or other coals that form furnace deposits. Accordingly water lances were developed to clean larger areas which use a water jet as the cleaning medium. A jet of water is sprayed back onto the wall it is mounted on in a spiral pattern as it is inserted into the furnace.

More recently, particularly since 1990, water cannons have been used for de-slagging as they have a number of advantages over conventional wall blowers and water lances. Water cannons spray a jet of water from an opening in the furnace wall to the opposite and adjoining walls as they allow for 90° of movement in both the vertical and horizontal planes. Robotic control mechanisms are used to achieve accuracy in positioning and cleaning. As few as four cannons, one on each wall, can clean an entire furnace, thereby replacing forty or more water lances .

The water cannons spray a concentrated water jet across the boiler and impact on the slagged wall surfaces and break up the slag due to the impacted water which penetrates the top most layer and expands into steam.

Water cannons are also beneficial in that they can clean areas of the furnace that cannot be outfitted with wall blowers or water lances. Water cannons can reach division walls, nose arches, and lower slope tubes in boilers.

Water cannon pressure is typically 175 psi, but can be varied from 150 to 700 psi with a possible flow rate of between 100 to 3,000 gallons per minute with a velocity of at least 20 feet per second. These perimeters can of course be varied depending upon the size of furnace section being treated and the nature of the encrustation or slagging.

Selective non-catalytic reduction (SNCR) has been used for many years to reduce the oxides of nitrogen in combustion processes. SNCR has been used for the reduction of NOx to meet regulatory limits by a chemical process in the combustion effluent. This is generally accomplished by the homogeneous distribution of injected SNCR reagent into the furnace's flue gas combustion stream. Often times one or two selected temperature zones of a furnace flue gas combustion system are the locations for injection which are determined using a predictive computational fluid dynamic model and a chemical kinetic model based on surveyed combustion parameters and configurations of the furnace flue gas combustion system.

SNCR uses a reagent, either urea or anhydrous ammonia, sprayed directly into the furnace at specified locations to induce a reaction between the reagent and the nitrogen oxide in the flue gas. This reduction reaction produces elemental nitrogen and water vapor from a portion of the NOx pollutant in the gases as well as some other byproducts.

The SNCR reaction is best achieved in locations where the furnace gases are projected to be 1,800-2,000 degrees F. In order to pinpoint the correct locations, typical SNCR design involves predictive modeling to determine injection locations. In order to cover the large volume and potential locations, typically SNCR injection systems include multiple wall injectors. At each injector location, a furnace wall penetration is required with mounting hardware, piping for the reagent and atomization air. Typically SNCR wall injectors use a two-phase sonic, tube-in-tube air cooled nozzle-injector technology wherein compressed air is used to atomize the reagent into fine droplets in the furnace.

In addition, in order to meet NOx reduction demands over the load range, the injector array described above may be duplicated at multiple elevations. Different elevations help to provide the reagent injection at variable load points and can help with tuning using the control system. On large boilers where substantial NOx reduction cannot be achieved with wall injectors alone, longer retractable injector nozzles are added that help transport the reagent mixture further into the furnace volume to target super heater areas where sprayers by the standard wall injector arrangement is ineffective and cause tube damage. The addition of the long retractable nozzles add substantial capital and maintenance cost with limited return or minimal improvement in NOx reduction.

The remainder of the SNCR system equipment includes the piping and control systems. Pumping, metering and mixing skids are also required to regulate the flow of reagent and the dilution of the reagent from the storage tanks. Storage tanks are typically located outdoors as near to the boiler as practical along with an unloading station, forwarding pumps, a containment basin, etc.

SNCR injection systems, including long retractable nozzles, are exceptionally expensive to install and maintain, and the payback from NOx reduction is economically prohibitive. It is a principal object of the present invention to eliminate or reduce the requirement of expensive SNCR injection systems for injecting the reagent into the furnace while simultaneously reducing furnace slagging.

### SUMMARY OF THE INVENTION

The SNCR method of the present invention incorporates the use of water cannons already installed in the combustion chamber of the furnace or boiler for removing combustion incrustation to deliver the SNCR reagent. The industry previously considered the use of water cannons for the delivery of a reagent as being unsuitable and impractical.

The method of the present invention utilizes water cannons installed in a solid fuel combustion furnace for selective non-catalytic reduction and removal of encrustation and slagging by injecting and directing jet streams of liquid NOx reducing reagent, with or without dilution water mixing, into combustion zones and radiant section and convective paths of the furnace with the water cannons as controlled by intelligent knowledge-based control algorithms. The control algorithms are based upon continuously monitored online-measured flue gas temperature, O₂, CO and NOx mapping data profiles for the furnace.

With the teachings of the present invention, water cannon's conventional function of soot blowing combustion produced ash deposits off heat transfer surfaces of combustion systems is expanded to include additional functions to reduce nitrogen oxides (Nox) emissions, as well as further improved cleanliness and increased heat rate, as guided by intelligent continuous online-measured flue gas temperature, O₂ CO and NOx mapping data profiles and knowledge-based control algorithms that maximize both slag removal and NOx reduction.

The method of the present invention couples online real-time measured flue gas temperature, O₂, CO and NOx mapping data to intelligently direct water cannons, via knowledge-based (highway of SNCR reagent-NOx reactions, key performance indicators, and online data) control algorithms to better aim its spraying mechanism to include nitrogenous NOx control reducing agents, such as urea and ammonia (i.e., the SNCR reagents) to effect NOx reduction to a higher level unachievable by conventional SNCR where the injections also result in more effective slag removal and cleaner heat transfer surfaces.

The water cannon was developed as a way to eliminate dozens of wall soot blowers, reduce maintenance and improve cleaning across a large furnace cavity. SNCR limitations and drawbacks has to do with multiple penetrations, difficulty in delivering the reagent to a large furnace and achieving the desired results. The larger the furnace and the more operating modes, the more complex and costly the SNCR system becomes. The process and apparatus of the present invention combines these two technologies of SNCR delivery and water cannons into a system that uses the best features of both technologies to deliver cost effective NOx reduction. This is contrary to the beliefs and understandings of the industry that this was not possible or practical because of the significantly higher flow of water into the boiler, heat rate penalty and fan impacts encountered with water cannons. The inventor discovered that the flow of water required per water cannon lance is substantially identical to the total flow of reagent to water solution on a conventional SNCR injection system. What was confirmed by the inventor is that with the right dilution of reagent in water, the present invention can put the same amount of reagent into a boiler as a typical SNCR system of lances with the same amount of water. The concern or belief that the flow rates of water cannons are so significantly different that SNCR administration could not be achieved without significant changes to the typical water cannon equipment, proved to be false.

The conventional water cannon injection lance has a nozzle designed for pressure and flow that will result in a tight stream of fluid with enough energy to penetrate the furnace gases and reach the far wall without losing all the energy needed to perform the cleaning duty. The nozzle design for the water cannon utilized in the process of the present invention uses high pressure and high flow to deliver a dense fog like spray pattern that can be aimed and adjusted as needed to tune the NOx reduction. The goal of the injection is not to shoot a stream across the furnace volume but rather to direct a large spray out into the hot furnace gases with enough energy to reach the location for maximum reagent utilization. The reagent concentration, flow rate, pressure and spray pattern are regulated to achieve the intended results. The balance of the system of the present invention is a combination of the standard water cannon auxiliaries for piping, pumping and controls along with the standard SNCR system for reagent unloading, storage, dilution, piping and controls required to achieve the supply requirements.

The process design of the present invention includes temperature mapping of the boiler over the operating range. The use of computational fluid dynamic modeling of the furnace with integration of test data is used in the design, with integration of advanced instrumentation with the system control for long term optimization. Systems for in situ monitoring of furnace exit gas temperature, real time NOx, O₂ and CO measurement are used to improve efficiency and reagent utilization, while minimizing any impact on boiler performance and overall heat rates.

The reagent (urea ammonia water or anhydrous ammonia) in water cannon delivered solution is typically 40% to 60% urea by weight or 19% to 29% ammonia water by weight. The mixture is administered under high velocity and high blast flow rate to the interior of the furnace or boiler for reduction of pollutant emissions with the water cannons. Typical water cannon blast exit velocity is regulated to be 20 feet per second to 400 feet per second and typical blast flow rate is regulated to be 10 to 400 gallons per minute.

The water cannons are provided with nozzles which have spray patterns which are adjusted by changing spray tips in order that the nozzles may be adjusted to provide an optimum spray pattern for SNCR. The spray patterns and nozzle adjustments can also be remotely controlled by computer control as are other operating parameters of the water cannons. In addition, only selected water cannons may be utilized as desired or required.

Also, another important feature of the present invention is that the water cannons may be used simultaneously for SNCR and de-slagging or may be readily switched from an SNCR function to a de-slagging function, switching from a reagent mixture to a de-slagging compound and otherwise remotely controlling the spray pattern and nozzle spray configuration of the selected water cannons.

Another advantage of the system of the present invention is that the water cannons are positioned at a more accessible lower location in the boiler than sprayers in typical SNCR injection systems. Also, instead of a conventional retractable injection lance that has a set spray pattern and a set elevation, the system of the present invention provides an SNCR injection system wherein one is able to point the water cannon where needed and adjust the spray pattern, and the system can be quickly switched for spraying a de-slagging compound thereby eliminating the need for expensive SNCR injection systems. The end result is a simple, robust, flexible, and cost effective alternative for boiler operators and owners for NOx reduction goals.

The unique features of the method and apparatus of the present invention as compared to the competing technology suppliers, is fewer but larger injection lances, aiming capability of the lance, integration of the targeting with operation, enhancement with advanced incrementation for furnace effluent gas temperature control, slag deposition reduction, and more effective control of NOx. Potential further enhancement includes the addition of other chemical compounds, such as magnesium hydroxide, ammonia hydroxide, or other chemical compounds, or suspension mixtures based on future research in this area.

### BRIEF DESCRIPTION OF THE DRAWINGS

Other objects and advantages appear hereinafter in the following description and claims. The accompanying drawings show, for the purpose of exemplification, without limiting the scope of the invention or the appended claims, certain practical embodiments of the present invention, wherein:

FIG. 1 is a process schematic diagram illustrating the method and apparatus of the present invention;

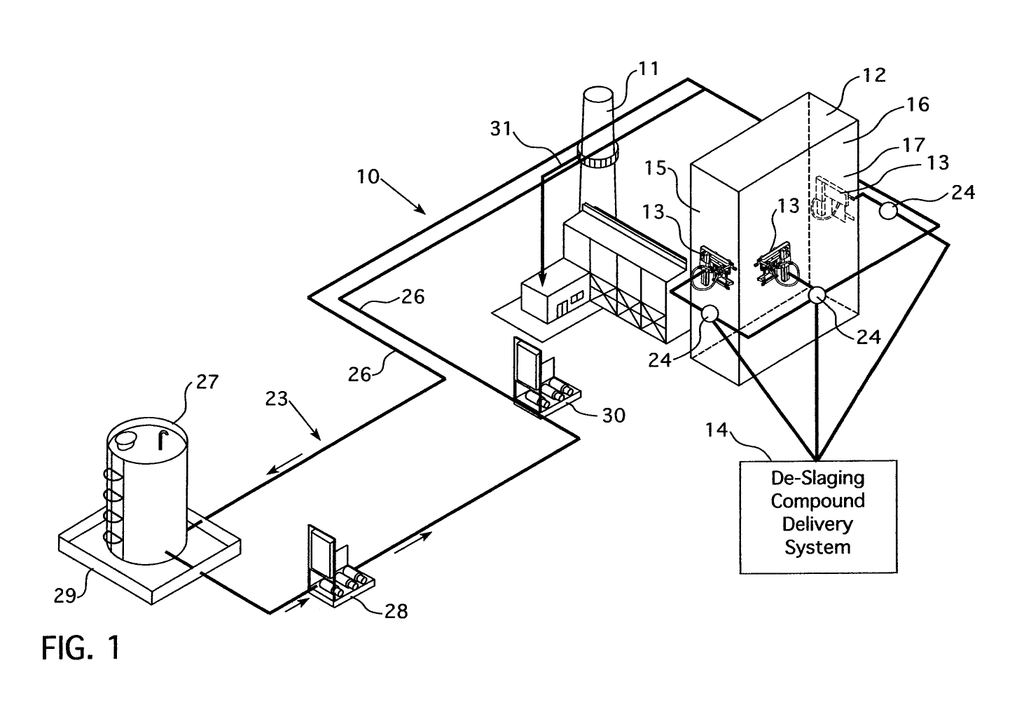

FIGS. 2 and 3 are respectively a side and rear isometric view with parts removed of a water cannon assembly adapted for the method and apparatus of the present invention.

FIG. 4 is a schematic illustration of a fossil fuel boiler illustrating the sensors for sensing temperature, NOx, O₂ and CO mapping points to control release of SNCR reagent; and

FIG. 5 is a block diagram of the process of the present method.

### DETAILED DESCRIPTION OF THE PREFERRED EMBODIMENTS

Referring to the drawings, the apparatus 10 of the present invention is illustrated for selective non-catalytic reduction (SNCR) of pollutant emissions in fossil fuel combustion effluent emanating from stack 11 of fossil fuel combustion furnace 12 having articulatable water cannons 13 installed for removing combustion incrustation in the furnace 12. Water cannons 13 are connected to a source of de-slagging compound from a conventional de-slagging compound delivery system 14 under high pressure for injection by water cannons 13 into furnace 12.

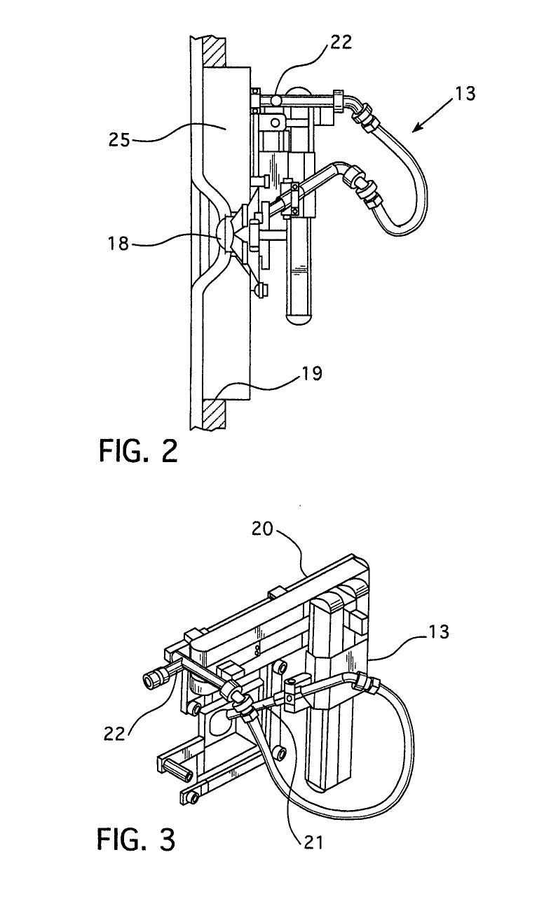

As is better illustrated in FIGS. 2 and 3, the water cannons 13 in this embodiment are provided in walls 15 and 17 of furnace 12. Each of the water cannons 13 includes an adjustable nozzle 18 positioned within wall box 25 mounted in wall port 19 of furnace 13 in order to project a stream of fluid, such as water with a de-slagging compound, into the interior volume of the furnace 13. Nozzle 18 includes a ball pivot joint as illustrated to permit adjustment of the direction of the stream of fluid by remote manipulation of external hardware 20 that allows the lance 21 to be indexed in the X and Y directions in a conventional manner to direct the water jet and trace out the preprogrammed pattern of the area to be cleaned. The adjustable nozzle 18 sprays a tight stream of water or water mixture across the furnace to the opposite or adjacent wall and is moved in a programmed manner to clean a designated area as with, for example, a CNC control.

Water cannons 13 are also alternatively or simultaneously connected to a mixture of reagent and water under high pressure through supply pipes 22 to a mixture of reagent and water under high pressure supplied from system 23 whereby the water cannons 13 may be selectively switched from a de-slagging function to an SNCR function or both with solenoid operated switching valves 24.

The SNCR system 23 includes piping 26 and control systems conventionally provided for de-slagging systems, including a storage tank 27 for storing the reagent urea or anhydrous ammonia in concentrated form, circulation skid at 28 for circulating the reagent in pipes 26, a containment basement 29 for spill protection, and a pumping, metering and mixing skid 30 for mixing and metering the reagent in the desired amount with the water and delivering the mixture under high pressure to the water cannons 13.

As with de-slagging, pollutant emissions (CO or NOx) as well as temperature and O₂ are continuously monitored by sensors 31 for feedback with conventional automated control to a conventional automated control system that is provided to run the control drives on the water cannons 13, monitor wall conditions using embedded furnace wall heat flux sensors, and providing sequencing and timing of SNCR and cleaning events and for also remotely adjusting nozzles 18 of water cannons 13 to provide an optimum spray pattern for SNCR and/or de-slagging.

As previously explained, the most prevalent pollutant in the affluent emissions is NOx and the typical reagent is either urea or anhydrous ammonia.

The water cannons 13 are remotely articulated for selective aiming of the spray and selecting an optimum pattern of the spray ejected from the water cannons to provide pollutant reduction through the use of conventional automated control techniques already in place for manipulation of the water cannon 13 for de-slagging functions, with the exception that the water cannon nozzles 18 for the method and apparatus of the present invention are also provided with remotely adjustable nozzles for additionally providing adjustment of the spray patterns.

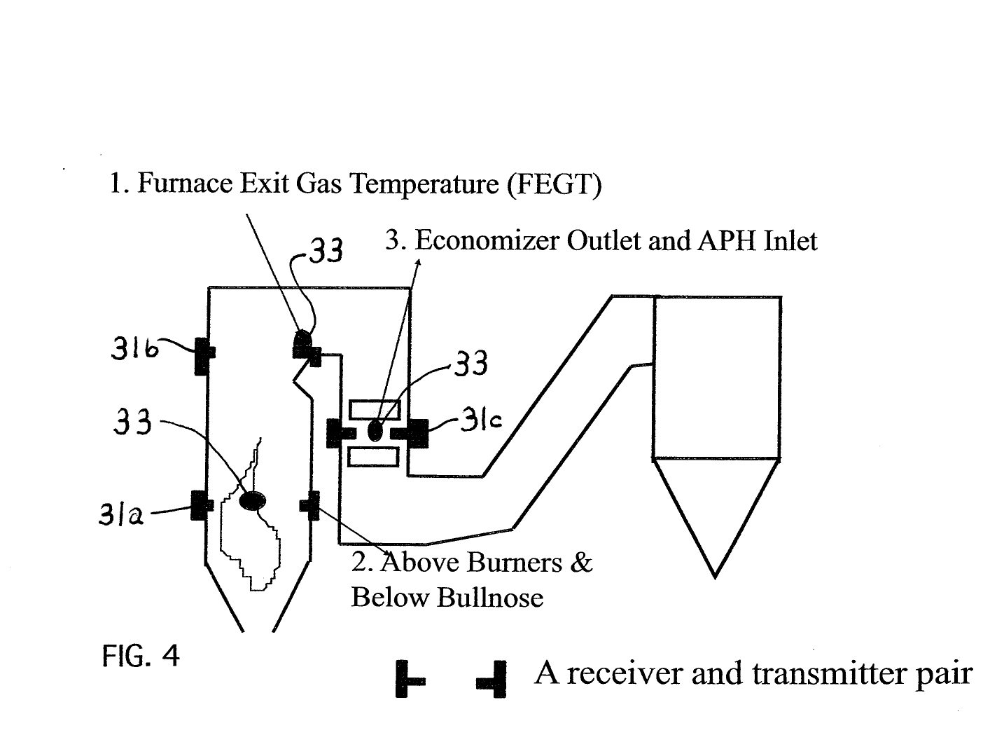

Referring to FIG. 4, temperature, NOx, O₂ and CO are monitored and measured by sensor pairs 31a, 31b and 31c above the burners and below the bullnose, at the furnace exit and at the economizer outlet and ABH inlet respectively. Mapping profiles are generated, usually in two dimensional form or even in three dimensional form in a control (such as a CNC) located within circulation skid 28, mixing skid thirty and the general controls provided with water cannons 13 to guide the water cannons 13 by knowledge-based control logic. A metered amount of nitrogenous reducing reagent to effect NOx reduction and chill/soot blow (wall tubes, super-heater, re-heater areas in locations 1 and 2 in FIG. 4, and a fine mist of steam/water to soot blow and shear off slag to also include economizer in location 3. This capability results in more effective chill-and- shear of slags as well as more favorable NOx emissions reduction.

It is important to note for the reason of minimizing NH3 slip, conventional SNCR prefers to be operated on the hotter side of SNCR reagent's temperature window, often times a local hot spot could become too hot for SNCR due to slag formation, higher O₂ and/or burning a higher heat value coal. The knowledge-based intelligence from this invention provides a spray with a chilling effect that puts NCR reactions back to the optimum SNCR's NOx reaction window to increase NOx removal efficiency. This and the capability that cannons 13 can inject to previously unreachable SNCR locations with knowledge guided aim from temperature, NOx, O₂ and CO monitored online data, SNCR reagent-NOx reactions, and boiler system's key performance indicators, push NOx reduction performance to an ultra high level unachievable by conventional SNCR.

Furthermore, the prescribed amount of SNCR reagent required is precisely based on real online monitored conditions for that particular water cannon, saving reagent and its preparation cost. This capability significantly improves NOx emissions reduction, heat transfer surface cleanliness, and its operational economics.

The temperatures monitored by sensors 31a, 31b and 31c are preferred to be profiled in 2-D or 3-D by either an Acoustic Pyrometer or Laser Spectroscopy. Conventional Optical Pyrometer may also provide temperature data, however it is not as accurate, particularly on low ash fuels because it measures light emissions of particulate (fly ash). Its use is inefficient because it operates on a single point with limited reach of a length to 20 feet.

Multiple receiver/transmitter pairs in sensors 31a, 3b and 31c, as well as boiler penetrations need to be installed for Acoustic Pyrometers, but no tube bends like Optical Pyrometers often require. The instrument will effectively measure across a complete 2-D (or 3-D) plane at multiple elevations, including water walls, super heater, reheat and convection zones on through to the air heaters of a combustion system.

Laser spectroscopy transmits specific wave lengths of laser (absorption peaks) across the boiler and collected by a receiver. It is more costly than Acoustic Pyrometer. Laser spectroscopy requires no cooling, and it can measure multiple 2-D or 3-D paths just like those by an Acoustic Pyrometer, but it also measures CO, CO₂, O₂, and H₂O.

The temperatures can be repeatedly checked by sensors 33 for accuracy with fireside compatible IR cameras, one camera at a single point. A top choice and common measuring point is above the Over Fire Air and below the bullnose arch. Additional locations, such as above the burners and below the bullnose and at the economizer are determined by accessability, needs and economics.

Water cannon introduced SNCR reagent requires minimum or no dilution to a stock solution; 40% to 60% urea by weight or 19-29% ammonia water by weight. This significantly minimizes or completely eliminates the large dilution water resource consumption and dilution water pumping and metering equipment required. It substantially reduces water injection caused heat loss, provides a NOx reduction level unachievable by typical SNCR, and is more effective in reagent utilization economics.

When urea is injected into the furnace, it will either be oxidized or it will react with NOx. Therefore, if only 50% aqueous urea is injected into the furnace without dilution water, there would be a heat gain, which is a great benefit relative to normally 1.5 to 5% heat loss by wall SNCR injectors.

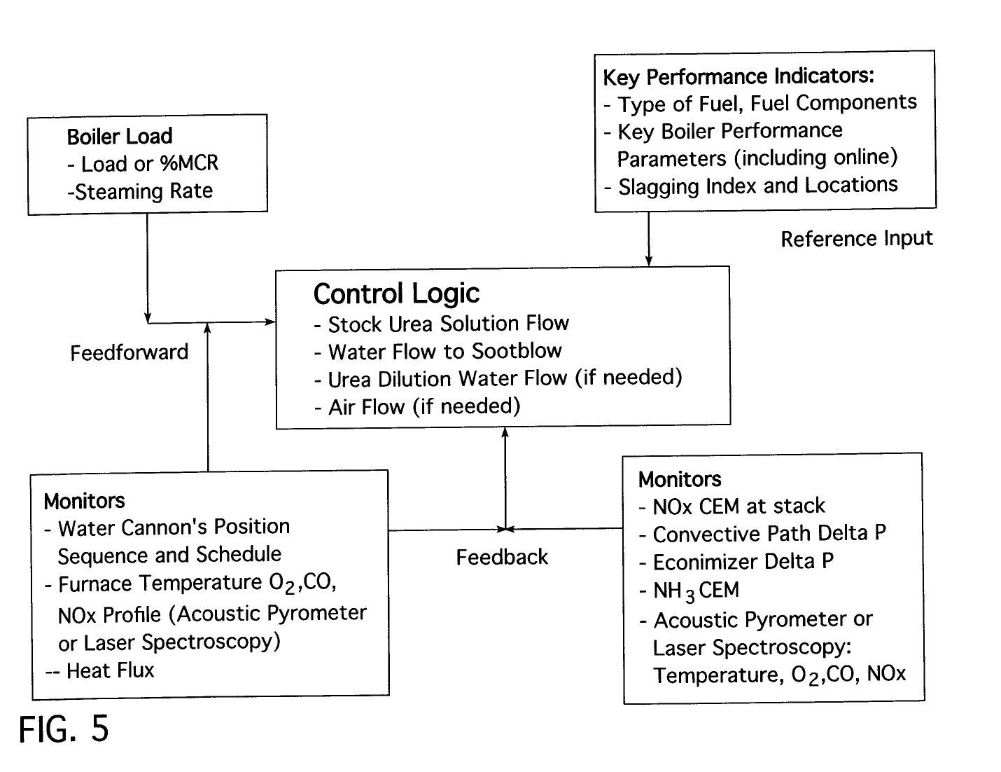

The temperature, O₂, CO and NOx mapping data are profiled into histograms called a “Look-Up Table” during combustion unit's initial testing for a given fuel and load, and the information is used in a control logic to estimate approximate need for cleaning and NOx reduction. In this regard, see the control logic block diagram of FIG. 5. This data is used, together with knowledge-based input of NOx-reagent reactions and boiler system's online key performance indicators to guide online injections based on real-time measured temperature, O₂, CO and NOx data to shorten the decision making time and to achieve much tighter control and the highest cleanliness and heat rate even during intentional or unintentional fuel changes.

This improved capability makes NOx control at conventionally reachable locations more reagent efficient or at higher NOx reductions. The use of water cannons at normally SNCR unreachable locations, such as in more super heater cavities and in the furnace increases NOx removal to beyond and above conventional SNCR performances.

I claim:

1. A method of selective non-catalytic reduction (SNCR) of pollutant emissions in a solid fuel combustion furnace having water cannons installed for removing encrustation and slagging, comprising:
injecting and directing jet streams of liquid NOx reducing reagent, with or without dilution water mixing, into combustion zones and radiant section and convective paths of said furnace with said water cannons as controlled by intelligent knowledge-based control algorithms.

2. The method of claim 1, wherein said control algorithms are based upon continuously monitored online-measured flue gas temperature, O₂, CO and NOx mapping data profiles for said furnace.

3. The method of claim 2, including also de-slagging encrusted and slagged sections of said furnace with said water cannons using water/steam.

4. The method of claim 1, wherein said reagent is one or more of nitrogenous urea or ammonia water.

5. The method of claim 4, wherein said listed reagents also include steam/water.

6. The method of claim 4, wherein the urea is 40-60% urea by weight in water and the ammonia water is 17-29%, with or without dilution water.

7. The method of claim 1, wherein said water cannons are provided with a blast exit velocity of at least 20 ft/sec and a blast flow of 100 to 30,000 gallons/min.

8. The method of claim 1, wherein said water cannons are provided with nozzles having adjustable spray patterns and said nozzles are adjusted to provide an optimum spray pattern droplet size distribution for SNCR.

9. The method of claim 1, including the step of switching said water cannons to spray a de-slagging compound.

10. An apparatus for selective non-catalytic reduction (SNCR) of pollutant emissions in a solid fuel combustion effluent, comprising;
a solid fuel combustion furnace having articulable water cannons installed for removing combustion encrustation and slagging in said furnace, said water cannons connected to a source of a de-slagging compound under high pressure for injection by said water cannons into said furnace;
said water cannons also alternatively connected to a mixture of reagent, with or without dilution water mixing, under high pressure whereby selected of said water cannons may be utilized for an SNCR function, and
a control for controlling said water cannons for SNCR by intelligent knowledge-based control algorithms.

11. The apparatus of claim 10, wherein said control is adapted and programmed to continuously monitor, measure and map a data profile of flue gas temperature, O₂, CO and NOx in said furnace.

12. The apparatus of claim 11, wherein said control is connected to said furnace for monitoring said data in combustion zones and radiant and conductive paths in said furnace.

13. The apparatus of claim 10, wherein said water cannons are adjusted to provide an optimum spray pattern and droplet size distribution for SNCR.

14. The apparatus of claim 10, including a control for switching said water cannons to spray a de-slagging compound.
